(19) United States
(12) Patent Application Publication
(10) Pub. No.: US 2014/0356551 A1
(43) Pub. Date: Dec. 4, 2014

(54) MOLDED BODIES HAVING HIGH SURFACE QUALITY

(71) Applicant: Bayer Intellectual Property GmbH, Monheim (DE)

(72) Inventors: Thomas Thulke, Koln (DE); Ulrich Grosser, Kurten (DE); Martin Döbler, Dusseldorf (DE); Birte Sämisch, Koln (DE); Alexander Meyer, Dusseldorf (DE); Christoph Klinkenberg, Koln (DE); Rafael Oser, Krefeld (DE)

(21) Appl. No.: 14/360,961

(22) PCT Filed: Nov. 28, 2012
(86) PCT No.: PCT/EP2012/073875

§ 371 Date: May 28, 2014

(30) Foreign Application Priority Data
Nov. 30, 2011 (EP) 11191310.9

(51) Int. Cl. C08L 69/00; C23C 30/00; C08K 3/34; B29C 45/78

(52) U.S. Cl. CPC C08L 69/00; B29C 45/78; C23C 30/00; C08K 3/34; C08L 2205/035; C08K 2201/003; B29K 2069/00
USPC 427/576; 264/328.16; 524/451; 524/611; 524/493

(57) ABSTRACT

The invention relates to thermoplastic compositions comprising A) 30.0 to 100.0 parts by wt. of at least one aromatic polycarbonate, B) 0.0 to 50.0 parts by wt. of a rubber-modified graft polymer and/or vinyl copolymer, C) 0.00 to 50.00 parts by wt. of polyester, D) 5.0 to 50.0 parts by wt. of at least one inorganic filler having a particle shape selected from the group including spherical/cubic, tabular/discus-shaped and lamellar geometries, and E) 0.00 to 5.00 parts by wt. of further conventional additives. The invention further relates to thermoplastic shaped articles having a high surface quality, high dimensional stability and high heat distortion temperature, as well as thermoplastic moulding compositions and a process for the production of the shaped articles. The present invention moreover relates to the coated finished parts produced from the thermoplastic shaped parts.

The invention relates to thermoplastic shaped articles having a high surface quality as well as thermoplastic moulding compositions and a process for the production of the shaped articles. The present invention moreover relates to the coated finished parts produced from the thermoplastic shaped parts.

Thermoplastic shaped articles having a high surface quality are always required if it is a matter of production of planar finished parts which, for example for aesthetic reasons, are intended to impart a uniform or, if required, also a high gloss impression. A high surface quality is also of importance if a shaped article must be functionalized still further, for example by application of functional layers, which in themselves must likewise have a high surface quality. In this connection it would be a disadvantage if the shaped article which is to function as a support for the functional layers were already to have a poor surface.

Shaped articles having a high surface quality can be employed in various uses or finished parts. These include, inter alia, finished parts having a high reflecting power. An example of these are metallized shaped articles as floodlight reflectors which bundle the light of a lamp or emitter in order to generate a defined beam profile. However, the use of the shaped articles according to the invention is also of interest for use in the context of concentrators, i.e. reflecting mirrors in the photovoltaic field, which focus sunlight, for example, on to an optical structural element, which then guides it to a current-generating photovoltaic cell.

In the cases of use mentioned, however, severe heating of the substrate occurs due to the intensive action of heat of the sun or the radiation source, which in the case of the floodlight is higher in particular in the region of the light source than in other regions of the finished part.

This heating imposes particular requirements on the thermoplastic moulding compositions used for the production of the shaped articles with respect to ensuring a high dimensional accuracy while at the same time maintaining the high surface quality of the shaped article.

Light-guiding or light-reflecting shaped parts of plastic have already been described in the literature:

DE 3940436 C2 discloses a process for the production of a reflector, in particular for a motor vehicle headlamp. In this process, there are injected successively into a mould a thermoplastic material having a very low or no filler content, which fills up a part of the mould cavity, and then an isotropic thermoplastic material, which is reinforced by a mineral or organic filler.

DE 4404604 A1 provides a process for the production of reflectors of plastic for illumination devices of a rigid support shell provided with a skin of smooth thermoplastic, for example of polycarbonate or polybutylene terephthalate, which is coated with metal and over which is formed a rigid core of a thermosetting plastics material.

JP 2000322918 A, JP 11241005 and JP 11241006 disclose a reflector having good surface properties, a good heat stability and a high adhesion for metals. The metals here are applied to a shaped part of a plastics composition comprising polyester, polycarbonate, filler and further constituents. However, reflectors produced in this manner do not have the required dimensional stability and/or surface quality.

JP 2006240085 A describes a process for the production of a reflecting component having a high heat distortion temperature and good adhesion to galvanized surfaces, galvanized surfaces and the galvanizing step being disadvantageous and unsuitable for high-precision reflector uses.

It was therefore an object of the present invention to produce a shaped article which
can be produced under thermoplastic conditions
has a low isotropic coefficient of thermal expansion
has a high dimensional accuracy
has a high surface quality, which is also retained under exposure to heat
has the highest possible heat stability, but at least to 100° C.
can be metallized in vacuo and
has a high reflectance after the metallizing.

It has been possible to achieve the object described by the combination of an injection moulding process with dynamic temperature control of the mould and with the aid of reinforced thermoplastic moulding compositions according to the invention.

It has been found, surprisingly, that compositions comprising

A) 30-100 parts by wt., preferably 40-90 parts by wt., particularly preferably 50-85 parts by wt. of aromatic polycarbonate and/or aromatic polyester carbonate, preferably polycarbonate,

B) 0-50 parts by wt., preferably 0-40.0 parts by wt., particularly preferably 5.0-20.0 parts by wt. of rubber-modified graft polymer and/or vinyl copolymer,

C) 0-50.0 parts by wt., preferably 0-30.0 parts by wt., particularly preferably 10.0-25.0 parts by wt. of polyester, preferably PBT or PET,

D) 5.0-50.0 parts by wt., preferably 10.0-30.0 parts by wt., particularly preferably 15.0 to 25.0 parts by wt. of inorganic filler with a grain shape chosen from the group which includes spherical/cubic, tabular/discus-shaped and lamellar geometries.

E) 0-5.0 parts by wt., preferably 0.5-3.0 parts by wt., particularly preferably 0.75-1.25 parts by wt. of further conventional polymer additives,

wherein all the parts by weight stated in the present application are standardized such that the sum of the parts by weight of all components A+B+C+D+E in the composition is 100,

have the desired profile of properties.

In a particularly preferred embodiment, the composition consists only of the components A, D and E, and in a further preferred embodiment of the components A-E in the abovementioned amount contents.

### Component A:

Polycarbonates in the context of the present invention are both homopolycarbonates and copolycarbonates; the polycarbonates can be linear or branched in a known manner.

Aromatic polycarbonates and/or aromatic polyester carbonates according to component A which are suitable according to the invention are known from the literature or can be prepared by processes known from the literature (for the preparation of aromatic polycarbonates see, for example, Schnell, “Chemistry and Physics of Polycarbonates”, Interscience Publishers, 1964 and DE-AS 1 495 626, DE-A 2 232 877, DE-A 2 703 376, DE-A 2 714 544, DE-A 3 000 610, DE-A 3 832 396; for the preparation of aromatic polyester carbonates e.g. DE-A 3 007 934).

Aromatic polycarbonates are prepared e.g. by reaction of diphenols with carbonic acid halides, preferably phosgene, and/or with aromatic dicarboxylic acid dihalides, preferably benzenedicarboxylic acid dihalides, by the interfacial process, optionally using chain terminators, for example monophenols, and optionally using branching agents which are trifunctional or more than trifunctional, for example triphenols or tetraphenols. A preparation via a melt polymerization process by reaction of diphenols with, for example, diphenyl carbonate is likewise possible. Diphenols for the preparation of the aromatic polycarbonates and/or aromatic polyester carbonates are preferably those of the formula (I)

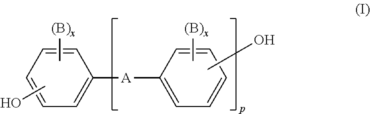

wherein
A is a single bond, C₁ to C₅-alkylene, C₂ to C₅-alkylidene, C₅ to C₆-cycloalkylidene, —O—, —SO—, —CO—, —S—, —SO₂—, C₆ to C₁₂-arylene, on to which further aromatic rings optionally comprising hetero atoms can be fused,
   or a radical of the formula (II) or (III)

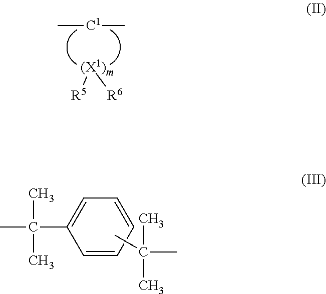

B is in each case C₁ to C₁₂-alkyl, preferably methyl, halogen, preferably chlorine and/or bromine,
x is in each case independently of each other 0, 1 or 2,
P is 1 or 0, and
R⁵ and R⁶ can be chosen individually for each X¹ and independently of each other denote hydrogen or C₁ to C₆-alkyl, preferably hydrogen, methyl or ethyl,
X¹ denotes carbon and
m denotes an integer from 4 to 7, preferably 4 or 5, with the proviso that on at least one atom X¹ R⁵ and R⁶ are simultaneously alkyl.

Preferred diphenols are hydroquinone, resorcinol, dihydroxydiphenols, bis-(hydroxyphenyl)-C₁-C₅-alkanes, bis-(hydroxyphenyl)-C₅-C₆-cycloalkanes, bis-(hydroxyphenyl)ethers, bis-(hydroxyphenyl) sulfoxides, bis-(hydroxyphenyl) ketones, bis-(hydroxyphenyl) sulfones and α,α-bis-(hydroxyphenyl)-diisopropylbenzenes and derivatives thereof brominated on the nucleus and/or chlorinated on the nucleus.

Particularly preferred diphenols are 4,4′-dihydroxydiphenyl, bisphenol A, 2,4-bis-(4-hydroxyphenyl)-2-methylbutane, 1,1-bis-(4-hydroxyphenyl)-cyclohexane, 1,1-bis-(4-hydroxyphenyl)-3,3,5-trimethylcyclohexane, 4,4′-dihydroxydiphenyl sulfide, 4,4′-dihydroxydiphenyl sulfone and di- and tetrabrominated or chlorinated derivatives thereof, such as, for example, 2,2-bis-(3-chloro-4-hydroxyphenyl)-propane, 2,2-bis-(3,5-dichloro-4-hydroxyphenyl)-propane or 2,2-bis-(3,5-dibromo-4-hydroxyphenyl)-propane. 2,2-Bis-(4-hydroxyphenyl)-propane (bisphenol A) is particularly preferred.

The diphenols can be employed individually or as any desired mixtures. The diphenols are known from the literature or obtainable by processes known from the literature.

Chain terminators which are suitable for the preparation of the thermoplastic, aromatic polycarbonates are, for example, phenol, p-chlorophenol, p-tert-butylphenol or 2,4,6-tribromophenol, but also long-chain alkylphenols, such as 4-[2-(2,4,4-trimethylpentyl)]-phenol, 4-(1,3-tetramethylbutyl)-phenol according to DE-A 2 842 005 or monoalkylphenols or dialkylphenols having a total of 8 to 20 carbon atoms in the alkyl substituents, such as 3,5-di-tert-butylphenol, p-iso-octylphenol, p-tert-octylphenol, p-dodecylphenol and 2-(3,5-dimethylheptyl)-phenol and 4-(3,5-dimethylheptyl)-phenol. The amount of chain terminators to be employed is in general between 0.5 mol % and 10 mol %, based on the sum of the moles of the particular diphenols employed.

The thermoplastic aromatic polycarbonates have average molecular weights (weight-average M_{w}, measured by GPC (gel permeation chromatography) with a polycarbonate standard) of from 10,000 to 200,000 g/mol, preferably 15,000 to 80,000 g/mol, particularly preferably 24,000 to 32,000 g/mol.

The thermoplastic, aromatic polycarbonates can be branched in a known manner, and in particular preferably by incorporation of from 0.05 to 2.0 mol %, based on the sum of the diphenols employed, of compounds which are trifunctional or more than trifunctional, for example those having three and more phenolic groups. Preferably, linear polycarbonates, further preferably based on bisphenol A, are employed.

Both homopolycarbonates and copolycarbonates are suitable. 1 to 25 wt. %, preferably 2.5 to 25 wt. %, based on the total amount of diphenols to be employed, of polydiorganosiloxanes having hydroxyaryloxy end groups can also be employed for the preparation of the copolycarbonates according to the invention according to component A. These are known (U.S. Pat. No. 3,419,634) and can be prepared by processes known from the literature. Copolycarbonates containing polydiorganosiloxane are likewise suitable; the preparation of copolycarbonates containing polydiorganosiloxane is described, for example, in DE-A 3 334 782.

Preferred polycarbonates are, in addition to the bisphenol A homopolycarbonates, the copolycarbonates of bisphenol A with up to 15 mol %, based on the sum of the moles of diphenols, of other diphenols mentioned as preferred or particularly preferred, in particular 2,2-bis-(3,5-dibromo-4-hydroxyphenyl)-propane.

Aromatic dicarboxylic acid dihalides for the preparation of aromatic polyester carbonates are preferably the diacid dichlorides of isophthalic acid, terephthalic acid, diphenyl ether 4,4′-dicarboxylic acid and of naphthalene-2,6-dicarboxylic acid.

Mixtures of the diacid dichlorides of isophthalic acid and of terephthalic acid in a ratio of between 1:20 and 20:1 are particularly preferred.

A carbonic acid halide, preferably phosgene, is additionally co-used as a bifunctional acid derivative in the preparation of polyester carbonates.

Possible chain terminators for the preparation of the aromatic polyester carbonates are, in addition to the monophenols already mentioned, also chlorocarbonic acid esters thereof and the acid chlorides of aromatic monocarboxylic acids, which can optionally be substituted by C₁ to C₂₂-alkyl groups or by halogen atoms, and aliphatic C₂ to C₂₂-monocarboxylic acid chlorides.

The amount of chain terminators is in each case 0.1 to 10 mol %, based on the moles of diphenol in the case of the phenolic chain terminators and on the moles of dicarboxylic acid dichloride in the case of monocarboxylic acid chloride chain terminators.

One or more aromatic hydroxycarboxylic acids can additionally be employed in the preparation of aromatic polyester carbonates.

The aromatic polyester carbonates can be either linear or branched in a known manner (in this context see DE-A 2 940 024 and DE-A 3 007 934), linear polyester carbonates being preferred.

Branching agents which can be used are, for example, carboxylic acid chlorides which are trifunctional or more than trifunctional, such as trimesic acid trichloride, cyanuric acid trichloride, 3,3′,4,4′-benzophenonetetracarboxylic acid tetrachloride, 1,4,5,8-naphthalenetetracarboxylic acid tetrachloride or pyromellitic acid tetrachloride, in amounts of from 0.01 to 1.0 mol-% (based on the dicarboxylic acid dichlorides employed), or phenols which are trifunctional or more than trifunctional, such as phloroglucinol, 4,6-dimethyl-2,4,6-tri-(4-hydroxyphenyl)-hept-2-ene, 4,6-dimethyl-2,4,6-tri-(4-hydroxyphenyl)-heptane, 1,3,5-tri-(4-hydroxyphenyl)-benzene, 1,1,1-tri-(4-hydroxyphenyl)-ethane, tri-(4-hydroxyphenyl)-phenylmethane, 2,2-bis[4,4-bis(4-hydroxyphenyl)-cyclohexyl]-propane, 2,4-bis(4-hydroxyphenylisopropyl)-phenol, tetra-(4-hydroxyphenyl)-methane, 2,6-bis(2-hydroxy-5-methylbenzyl)-4-methylphenol, 2-(4-hydroxyphenyl)-2-(2,4-dihydroxyphenyl)-propane, tetra-(4-[4-hydroxyphenylisopropyl]-phenoxy)-methane, 1,4-bis[4,4′-dihydroxytriphenyl)-methyl]-benzene, in amounts of from 0.01 to 1.0 mol %, based on the diphenols employed. Phenolic branching agents can be initially introduced with the diphenols; acid chloride branching agents can be introduced together with the acid dichlorides.

The content of carbonate structural units in the thermoplastic, aromatic polyester carbonates can vary as desired. Preferably, the content of carbonate groups is up to 100 mol %, in particular up to 80 mol %, particularly preferably up to 50 mol %, based on the sum of ester groups and carbonate groups. Both the ester and the carbonate content of the aromatic polyester carbonates can be present in the polycondensate in the form of blocks or in random distribution.

The thermoplastic, aromatic polycarbonates and polyester carbonates can be employed by themselves or in any desired mixture.

### Component B

Component B includes one or more graft polymers of

B.1 5 to 95, preferably 20 to 90 wt. %, particularly preferably 30 to 60 wt. % of at least one vinyl monomer on

B.2 95 to 5, preferably 80 to 10 wt. %, particularly preferably 70 to 40 wt. % of one or more graft bases.

The glass transition temperature of the graft base is preferably <10° C., further preferably <0° C., and particularly preferably <−20° C.

The graft base B.2 in general has an average particle size (d₅₀ value) of from 0.05 to 10.00 μm, preferably 0.10 to 5.00 μm, further preferably 0.20 to 1.00 μm, and particularly preferably from 0.25 to 0.50 μm.

Monomers B.1 are preferably mixtures of

B.1.1 50 to 99 parts by wt. of vinylaromatics and/or vinylaromatics substituted on the nucleus (such as styrene, α-methylstyrene, p-methylstyrene, p-chlorostyrene) and/or (meth)acrylic acid (C₁-C₈)-alkyl esters (such as methyl methacrylate, ethyl methacrylate) and

B.1.2 1 to 50 parts by wt. of vinyl cyanides (unsaturated nitriles, such as acrylonitrile and methacrylonitrile) and/or (meth)acrylic acid (C₁-C₈)-alkyl esters, such as methyl methacrylate, n-butyl acrylate, t-butyl acrylate, and/or derivatives (such as anhydrides and imides) of unsaturated carboxylic acids, for example maleic anhydride.

Preferred monomers B.1.1 are chosen from at least one of the monomers styrene, α-methylstyrene and methyl methacrylate, and preferred monomers B.1.2 are chosen from at least one of the monomers acrylonitrile, maleic anhydride and methyl methacrylate. Particularly preferred monomers are B.1.1 styrene and B.1.2 acrylonitrile.

Graft bases B.2 which are suitable for the graft polymers B are, for example, diene rubbers, EP(D)M rubbers, that is to say those based on ethylene/propylene and optionally diene, and acrylate, polyurethane, silicone, chloroprene and ethylene/vinyl acetate rubbers.

Preferred graft bases B.2 are diene rubbers, for example based on butadiene and isoprene, or mixtures of diene rubbers or copolymers of diene rubbers or mixtures thereof with further copolymerizable monomers (e.g. according to B.1.1 and B.1.2). Pure polybutadiene rubber is particularly preferred.

The glass transition temperature is determined by means of dynamic differential scanning calorimetry (DSC) in accordance with DIN EN 61006 at a heating rate of 101K/min with determination of the T_{g} as a midpoint determination (tangent method)

Particularly preferred polymers B are, for example, ABS polymers (emulsion, bulk and suspension ABS) such as are described e.g. in DE-OS 2 035 390 (=U.S. Pat. No. 3,644,574) or in DE-OS 2 248 242 (=GB 1 409 275) and in Ullmanns, Enzyklopädie der Technischen Chemie, vol. 19 (1980), p. 280 et seq. The gel content of the graft base B.2 is at least 30 wt. %, preferably at least 40 wt. % (measured in toluene).

The graft copolymers B are prepared by free radical polymerization, e.g. by emulsion, suspension, solution or bulk polymerization, preferably by emulsion or bulk polymerization.

Particularly suitable graft rubbers are also ABS polymers which are prepared in the emulsion polymerization process by redox initiation with an initiator system of organic hydroperoxide and ascorbic acid in accordance with U.S. Pat. No. 4,937,285.

Since as is known the grafting monomers are not necessarily grafted completely on to the graft base during the grafting reaction, according to the invention graft polymers B are also understood as meaning those products which are produced by (co)polymerization of the grafting monomers in the presence of the graft base and are also obtained during the working up.

Suitable acrylate rubbers according to B.2 of the polymers B are preferably polymers of acrylic acid alkyl esters, optionally with up to 40 wt. %, based on B.2, of other polymerizable, ethylenically unsaturated monomers. The preferred polymerizable acrylic acid esters include C₁ to C₈-alkyl esters, for example methyl, ethyl, butyl, n-octyl and 2-ethylhexyl esters; haloalkyl esters, preferably halo-C₁-C₈-alkyl esters, such as chloroethyl acrylate, and mixtures of these monomers.

For crosslinking, monomers having more than one polymerizable double bond can be copolymerized. Preferred examples of crosslinking monomers are esters of unsaturated monocarboxylic acids having 3 to 8 C atoms and unsaturated monofunctional alcohols having 3 to 12 C atoms, or of saturated polyols having 2 to 40H groups and 2 to 20 C atoms, such as ethylene glycol dimethacrylate, allyl methacrylate; polyunsaturated heterocyclic compounds, such as trivinyl and triallyl cyanurate; polyfunctional vinyl compounds, such as di- and trivinylbenzenes; but also triallyl phosphate and diallyl phthalate. Preferred crosslinking monomers are allyl methacrylate, ethylene glycol dimethacrylate, diallyl phthalate and heterocyclic compounds which have at least three ethylenically unsaturated groups. Particularly preferred crosslinking monomers are the cyclic monomers triallyl cyanurate, triallyl isocyanurate, triacryloylhexahydro-s-triazine, triallylbenzenes. The amount of the crosslinking monomers is preferably 0.02 to 5.00, in particular 0.05 to 2.00 wt. %, based on the graft base B.2. In the case of cyclic crosslinking monomers having at least three ethylenically unsaturated groups, it is advantageous to limit the amount to less than 1 wt. % of the graft base B.2.

Preferred “other” polymerizable, ethylenically unsaturated monomers which can optionally serve for preparation of the graft base B.2 in addition to the acrylic acid esters are e.g. acrylonitrile, styrene, α-methylstyrene, acrylamides, vinyl C₁-C₆-alkyl ethers, methyl methacrylate and butadiene. Preferred acrylate rubbers as the graft base B.2 are emulsion polymers which have a gel content of at least 60 wt. %.

Further suitable graft bases according to B.2 are silicone rubbers having grafting-active sites, such as are described in DE-OS 3 704 657, DE-OS 3 704 655, DE-OS 3 631 540 and DE-OS 3 631 539.

The gel content of the graft base B.2 is determined at 25° C. in a suitable solvent (M. Hoffmann, H. Krömer, R. Kuhn, Polymeranalytik I und II, Georg Thieme-Verlag, Stuttgart 1977).

The average particle size d₅₀ is the diameter above and below which in each case 50 wt. % of the particles lie. It can be determined by means of ultracentrifuge measurement (W. Scholtan, H. Lange, Kolloid, Z. und Z. Polymere 250 (1972), 782-1796).

### Component C

Component C includes one or more thermoplastic polyalkylene terephthalates.

The polyalkylene terephthalates are reaction products of aromatic dicarboxylic acids or their reactive derivatives, such as dimethyl esters or anhydrides, and aliphatic, cycloaliphatic or araliphatic diols, and mixtures of these reaction products.

Preferred polyalkylene terephthalates comprise at least 80 wt. %, preferably at least 90 wt. %, based on the dicarboxylic acid component, of terephthalic acid radicals and at least 80 wt. %, preferably at least 90 wt. %, based on the diol component, of radicals of ethylene glycol and/or butane-1,4-diol.

The preferred polyalkylene terephthalates can comprise, in addition to terephthalic acid radicals, up to 20 mol %, preferably up to 10 mol %, of radicals of other aromatic or cycloaliphatic dicarboxylic acids having 8 to 14 C atoms or aliphatic dicarboxylic acids having 4 to 12 C atoms, such as e.g. radicals of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid.

The preferred polyalkylene terephthalates can comprise, in addition to radicals of ethylene glycol or butane-1,4-diol, up to 20 mol %, preferably up to 10 mol %, of other aliphatic diols having 3 to 12 C atoms or cycloaliphatic diols having 6 to 21 C atoms, e.g. radicals of propane-1,3-diol, 2-ethylpropane-1,3-diol, neopentyl glycol, pentane-1,5-diol, hexane-1,6-diol, cyclohexane-1,4-dimethanol, 3-ethylpentane-2,4-diol, 2-methylpentane-2,4-diol, 2,2,4-trimethylpentane-1,3-diol, 2-ethylhexane-1,3-diol, 2,2-diethylpropane-1,3-diol, hexane-2,5-diol, 1,4-di-(β-hydroxyethoxy)-benzene, 2,2-bis-(4-hydroxycyclohexyl)-propane, 2,4-dihydroxy-1,1,3,3-tetramethylcyclobutane, 2,2-bis-(4-β-hydroxyethoxyphenyl)-propane and 2,2-bis-(4-hydroxypropoxyphenyl)-propane (DE-A 2 407 674, 2 407 776, 2 715 932).

The polyalkylene terephthalates can be branched by incorporation of relatively small amounts of 3- or 4-functional alcohols or 3- or 4-basic carboxylic acids, e.g. in accordance with DE-A 1 900 270 and U.S. Pat. No. 3,692,744. Examples of preferred branching agents are trimesic acid, trimellitic acid, trimethylolethane and -propane and pentaerythritol.

Polyalkylene terephthalates which have been prepared solely from terephthalic acid and reactive derivatives thereof (e.g. dialkyl esters thereof) and ethylene glycol and/or butane-1,4-diol, and/or mixtures of these polyalkylene terephthalates are particularly preferred.

Mixtures of polyalkylene terephthalates comprise 1 to 50 wt. %, preferably 1 to 30 wt. % of polyethylene terephthalate and 50 to 99 wt. %, preferably 70 to 99 wt. % of polybutylene terephthalate.

The polyalkylene terephthalates preferably used in general have a limiting viscosity of from 0.4 to 1.5 dl/g, preferably 0.5 to 1.2 dl/g, measured in phenol/o-dichlorobenzene (1:1 parts by weight) at 25° C. in an Ubbelohde viscometer.

The polyalkylene terephthalates can be prepared by known methods (see e.g. Kunststoff-Handbuch, volume VIII, p. 695 et seq., Carl-Hanser-Verlag, Munich 1973).

### Component D:

These inorganic fillers are special inorganic particles having a grain shape chosen from the group which includes spherical/cubic, tabular/discus-shaped and lamellar geometries. A stalk-like grain shape is not suitable in the context of the present invention.

Inorganic fillers having a spherical or lamellar geometry, preferably in finely divided and/or porous form having a large external and/or internal surface area are suitable in particular. These are preferably thermally inert inorganic materials, in particular based on nitrides, such as boron nitride, or are oxides or mixed oxides, such as cerium oxide, aluminium oxide, or are carbides, such as tungsten carbide, silicon carbide or boron carbide, powdered quartz, such as quartz flour, amorphous SiO₂, ground sand, glass particles, such as glass powder, in particular glass spheres, silicates or alumosilicates, graphite, in particular highly pure synthetic graphite. In this context, quartz and talc are preferred in particular, and quartz (spherical grain shape) is most preferred.

The fillers used in the invention are characterized by an average diameter d_{50%} of from 0.1 to 10 μm, preferably from 0.2 to 8.0 μm, further preferably from 0.5 to 5 μm.

In a preferred embodiment, component D is finely divided quartz flours which have been prepared from processed quartz sand by iron-free grinding with subsequent air separation.

The silicates used in the invention are characterized by an average diameter d_{50%} of from 2 to 10 μm, preferably from 2.5 to 8.0 μm, further preferably from 3 to 5 μm, and particularly preferably of 3 μm, an upper diameter d_{95%} of from correspondingly 6 to 34 μm, further preferably from 6.5 to 25.0 μm, still further preferably from 7 to 15 μm, and particularly preferably of 10 μm being preferred.

Preferably, the silicates have a specific BET surface area, determined by nitrogen adsorption in accordance with ISO 9277, of from 0.4 to 8.0 m²/g, further preferably from 2 to 6 m²/g, and particularly preferably from 4.4 to 5.0 m²/g.

Silicates which are further preferred have only a maximum of 3 wt. % of secondary constituents, wherein preferably the content of

Al₂O₃ is <2.0 wt. %,

Fe₂O₃ is <0.05 wt. %,

(CaO+MgO) is <0.1 wt. %.

(Na₂O+K₂O) is <0.1 wt. %, in each case based on the total weight of the silicate.

Preferably, silicates having a pH, measured in accordance with ISO 10390 in aqueous suspension, in the range of 6 to 9, further preferably 6.5 to 8.0 are employed.

They moreover have an oil absorption number according to ISO 787-5 of from preferably 20 to 30 g/100 g.

A further advantageous embodiment uses talc in the form of finely ground types having an average particle diameter d₅₀ of <10 μm, preferably <5 μm, particularly preferably <2 μm, very particularly preferably <1.5 μm.

The grain size distribution is determined by air separation.

Inorganic fillers, in particular silicates, which have a coating with organosilicon compounds are particularly preferably employed, epoxysilane, methylsiloxane and methacrylsilane sizes preferably being employed. An epoxysilane size is particularly preferred.

The sizing of inorganic fillers is carried out by the general processes known to the person skilled in the art.

### Component E:

The compositions can comprise further additives as component E. Possible further additives according to component E are, in particular, conventional polymer additives, such as flameproofing agents (e.g. organic phosphorus or halogen compounds, in particular oligophosphate based on bisphenol A), antidripping agents (for example compounds of the substance classes of fluorinated polyolefins, e.g. polytetrafluoroethylene, the silicones and aramid fibres), lubricants and mould release agents, preferably pentaerythritol tetrastearate, nucleating agents, stabilizers (for example UV, heat and/or hydrolysis stabilizers and antioxidants), as well as dyestuffs and pigments (for example carbon black, titanium dioxide or iron oxide).

Stabilizers which are employed are, in particular, phosphorus-based and/or phenolic stabilizers, preferably tris(2,4-di-tert-butylphenyl) phosphite or 2,6-di-tert-butyl-4-(octadecanoxy-carbonylethyl)phenol and mixtures thereof.

### Compounding:

The preparation of the polymer compositions according to the invention comprising components A) to E) is carried out with the usual processes of incorporation by bringing together, mixing and homogenizing the individual constituents, the homogenizing in particular preferably taking place in the melt under the action of shearing forces. The bringing together and mixing are optionally carried out before the melt homogenization, using powder premixes.

Premixes of granules or granules and powders with the additives according to the invention can also be used.

Premixes which have been prepared from solutions of the mixing components in suitable solvents, homogenization optionally being carried out in solution and the solvent then being removed, can also be used.

In particular, the additives of the composition according to the invention can be introduced here by known processes or as a masterbatch.

The use of masterbatches is preferred in particular for introduction of the additives, masterbatches based on the particular polymer matrix being used in particular.

In this connection, the composition can be brought together, mixed, homogenized and then extruded in conventional devices, such as screw extruders (for example twin-screw extruders, TSE), kneaders or Brabender or Banbury mills. After the extrusion, the extrudate can be cooled and comminuted. Individual components can also be premixed and the remaining starting substances can then be added individually and/or likewise as a mixture.

The bringing together and thorough mixing of a premix in the melt can also be carried out in the plasticizing unit of an injection moulding machine. In this procedure, the melt is converted directly into a shaped article in the subsequent step.

### Injection Moulding Process:

The process of dynamic mould temperature control in injection moulding is characterized in that the mould wall is heated up swiftly before injection of the melt. Due to the elevated mould temperature, premature solidification of the melt is prevented, so that inter alia a higher casting accuracy of the mould surface is possible and the quality of the component surface improves. The temperature of the mould wall should be in the region of the Vicat temperature+/−20° C., preferably in the region+/−10° C., particularly preferably in the region+5° C. Dynamic mould temperature control is furthermore characterized in that the temperature of the mould wall after the injection operation is cooled down again as rapidly as possible to the original temperature and the component is cooled down to the mould release temperature in the mould in the conventional manner. For the examples mentioned in the following, dynamic mould temperature control with the aid of induction heating was used.

### Metallization:

The application of metals to the polymer can be effected via various methods, such as e.g. by vapour deposition or sputtering. The processes are described in more detail e.g. in “Vakuumbeschichtung vol. 1 to 5”, H. Frey, VDI-Verlag Düsseldorf 1995 or “Oberflächen- and Dünnschicht-Technologie” part 1, R. A. Haefer, Springer Verlag 1987.

In order to achieve a better adhesion of the metal and in order to clean the substrate surface, the substrates are usually subjected to a plasma pretreatment. Under certain circumstances, a plasma pretreatment can modify the surface properties of polymers. These methods are described e.g. by Friedrich et al. in Metallized plastics 5 & 6: Fundamental and applied aspects and H. Grünwald et al. in Surface and Coatings Technology 111 (1999) 287-296.

Further layers, such as corrosion-reducing protective sizes, can be applied in a PECVD (plasma enhanced chemical vapour deposition) or plasma polymerization process. In these, low-boiling precursors chiefly based on siloxane are vaporized in a plasma and thereby activated, so that they can form a film. Typical substances here are hexamethyldisiloxane (HMDSO), tetramethyldisiloxane, decamethylcyclopentasiloxane, octamethylcyclotetrasiloxane and trimethoxymethylsilane.

Possible metals are, preferably, Ag, Al, Ti, Cr, Cu, VA steel, Au, Pt, particularly preferably Ag, Al, Ti or Cr.

### Testing of the Moulding Compositions

### Heat Exposure Test

The sample sheets were stored in an oven at defined temperatures for in each case 1 h. The storage in the oven serves to imitate a possible exposure of the components to heat during later use. In this test, the sample sheets are stored in stages at an increasing oven temperature. In each case one set of test specimens is used per temperature stage. The maximum use temperature is defined as the temperature up to which no visible deterioration of the surface reflectance occurs.

### Measurement Parameters

The heat distortion temperature was measured in accordance with DIN ISO 306 (Vicat softening temperature, method B with a 50 N load and a heating rate of 120 K/h) on a test bar of dimensions 80×10×4 mm injection moulded on one side.

The coefficient of thermal expansion (CLTE) was measured in accordance with DIN ISO 11359-1,-2 (coefficient of linear thermal expansion, parallel/perpendicular, at 23 to 55° C. in the unit of 10⁻⁴/K).

The reflectance was measured on metallized sample sheets in accordance with ASTM E 1331-04. Separate measurements with gloss “specular included” (total reflection [%]) and measurements without gloss “specular excluded” (diffuse reflection [%]) were performed. The direct reflection [%] was calculated via the relationship Rdirect=Rtotal−Rdiffuse. A Hunter UltraScan PRO with incorporated photometer sphere was used as the measuring apparatus.

### Constituents Used:

### Component A1

Linear polycarbonate based on bisphenol A having an intrinsic viscosity of 1.255 in methylene chloride at 25° C. and a concentration of 0.5 g/100 ml.

### Component A2

Linear polycarbonate based on bisphenol A having an intrinsic viscosity of 1.270 in methylene chloride at 25° C. and a concentration of 0.5 g/100 ml.

### Component A3

Linear polycarbonate based on bisphenol A having an intrinsic viscosity of 1.290 in methylene chloride at 25° C. and a concentration of 0.5 g/100 ml.

### Component Ba (Pure B.1/SAN):

Copolymer of 77 wt. % of styrene and 23 wt. % of acrylonitrile having a weight-average molecular weight Mw of 130 kg/mol (determined by GPC), prepared by the bulk process.

Component Bb (Graft Polymer of B.1 and B.2 with a Silicone/Acrylate Graft):

Impact modifier, styrene/acrylonitrile-modified silicone/acrylate rubber, Metablen® SRK 200 from Mitsubishi Rayon Co., Ltd., CAS 178462-89-0.

Component Bc (Graft Polymer of B.1 and B.2 with a Polybutadiene Graft):

ABS prepared in the bulk polymerization process having an acrylonitrile:butadiene:styrene ratio of 21:10:69

### Component C1:

Linear polyethylene terephthalate having an intrinsic viscosity of 0.62, measured in phenol/o-dichlorobenzene (1:1 parts by wt.) at 25° C.

### Component D1:

A quarts flour from Quarzwerke GmbH (50226 Frechen, Germany) which is available under the trade name Sikron SF 600 (d₅₀=3 μm, d₉₅=10 μm, non-sized) was used.

### Component D2:

HTP Ultra 5C, talc from Imifabi S.p.A. with a talk having an SiO₂ content of 61.5%, an MgO content of 31%, an Al₂O₃ content of 0.4%. (average particle diameter: 0.5 μm)

### Component D3:

Glass fibre having an average diameter of 13.7 μm and an average length of 3.0-4 0 mm (sized for polycarbonate uses).

### Component E1:

Pentaerythritol tetrastearate as a lubricant/mould release agent

### Preparation of the Granules

The starting substances listed in Table 1 are compounded and granulated on a twin-screw extruder (ZSK-25) (Werner and Pfleiderer) at a speed of rotation of 225 rpm and a throughput of 20 kg/h at a machine temperature of 260° C.-290° C. The finished granules are processed to the corresponding test specimens on an injection moulding machine as described below.

### Production of the Test Specimens:

For the examples mentioned in the following, dynamic mould temperature control with the aid of induction heating was used. The test specimens are sample sheets of DIN AS size having various surface structures. The optical measurements were conducted in regions with high gloss surfaces. The mould and material temperatures set for production of the sample sheets are shown in the table “Properties and processing parameters”.

### Metallization Process:

The coating unit consisted of a vacuum chamber in which the samples were positioned on a rotating sample holder. The sample holder rotated at approx. 20 rpm. Before they were introduced into the vacuum chamber, the test specimens were blasted with ionized air in order to free them from dust. Thereafter, the vacuum chamber with the test specimens was evacuated to a pressure p of ≦1·10⁻⁵ mbar. A plasma was then ignited with argon gas to a pressure of p=0.1 mbar for 1 min with 500 W and the samples were exposed to this plasma (plasma pretreatment). The plasma source used was a diode arrangement consisting of 2 parallel metal electrodes, which was operated with an alternating frequency of 40 kHz and a voltage of greater than 1,000 V. Thereafter, the samples were metallized. For this, Ar gas was let in with a pressure of 5·10⁻³ mbar. By means of a DC magnetron, an aluminium layer approx. 100 nm thick was applied to the samples with a power density of 6.4 W/cm². The sputter time was 2.5 min. Thereafter, a corrosion protection layer of HMDSO was applied by means of plasma polymerization. For this, HMDSO was vaporized and the vapour was let into the vacuum chamber until a pressure of approx. 0.08 mbar resulted. Thereafter, a plasma was ignited at 1,500 W with the diode arrangement described above and the corrosion protection layer was applied for 1 minute.

### Compositions:

| | Composition [wt. %] | | | | | | |
|---|---|---|---|---|---|---|---|
| | V0 | V1 | V2 | 1 | 2 | 3 | 4 |
| A1 | | — | 35% | 63% | — | — | 82% |
| A2 | 99.7% | 62% | | | | 49.3% | — |
| A3 | | | 50.5% | — | 80% | — | |
| Ba | — | 27% | — | — | — | 16% | — |
| Bb | — | 0.5% | — | — | — | 6% | — |
| Bc | — | — | — | — | — | 8% | 8.6% |
| C1 | — | — | — | 21% | — | — | — |
| D1 | — | — | — | — | 20% | — | — |
| D2 | — | — | — | 15% | — | 20% | 8.6% |
| D3 | — | 10% | 14% | — | — | — | — |
| E1 | 0.3% | 0.5% | 0.5% | 1% | — | 0.7% | 0.8% |

### Properties and Processing Parameters:

| | Composition | | | | | | |
|---|---|---|---|---|---|---|---|
| | Comparative examples | | | Examples (according to the invention) | | | |
| | V0 | V1 | V2 | 1 | 2 | 3 | 4 |
| CLTE parallel [10⁻⁴/K] | 0.65 | 0.38 | 0.35 | 0.45 | 0.5 | 0.4 | 0.55 |
| CLTE perpendicular [10⁻⁴/K] | 0.65 | 0.62 | 0.65 | 0.45 | 0.5 | 0.56 | 0.65 |
| Vicat @ 50N; 50° C./h [° C.] | 143 | 132 | 144 | 140* | 143 | 128 | 140 |

Normal processing

| | | | | | | | |
|---|---|---|---|---|---|---|---|
| Material temperature [° C.] | 300 | 280 | 315 | 280 | 310 | 280 | 270 |
| Mould temperature [° C.] | 100 | 100 | 130 | 80 | 115 | 100 | 100 |
| Visual evaluation (before | ++ | −− | −− | − | ∘ | ∘ | − |
| metallization) | | | | | | | |
| Direct reflection after | 84.01 | 74.66 | 81.08 | 62.18 | 64.17 | 74.63 | 59.41 |
| metallization [%] | | | | | | | |

Processing with dynamic mould temperature control:

| | | | | | | | |
|---|---|---|---|---|---|---|---|
| Material temperature [° C.] | 300 | 280 | 315 | 280 | 310 | 280 | 270 |
| Mould temperature [° C.] | 100 | 100 | 130 | 80 | 115 | 100 | 100 |
| Short-term mould temp. [° C.] | 156 | 143 | 156 | 153 | 153 | 147 | 155 |
| Visual evaluation (before | ++ | + | ∘ | ++ | ++ | ++ | ++ |
| metallization) | | | | | | | |
| Direct reflection after | 81.62 | 81.60 | 82.11 | 82.87 | 82.57 | 82.36 | 80.32 |
| metallization [%] | | | | | | | |
| Maximum use temp. [° C.] | 135 | 100 | 120 | 115 | 125 | 100 | 125 |

*Vicat @ 50N; 120° C./h [° C.]

Determination of the Max. Use Temperatures on Examples 1 and 2 According to the Invention:

| | Direct reflection % | | |
|---|---|---|---|
| Temperature | 1 | 2 | 3 |
| 25° C. | 82.36 | 82.57 | 80.32 |
| 105° C. | 82.12 | 82.76 | 79.90 |
| 110° C. | 82.25 | 82.30 | 80.59 |
| 115° C. (=maximum temperature for Example 1) | 81.14 | 82.26 | 80.30 |
| 120° C. | 76.09 | 82.44 | 80.08 |
| 125° C. (=maximum temperature for Example 2, 3) | 67.09 | 82.48 | 79.35 |
| 130° C. | 41.87 | 80.06 | 62.91 |
| 135° C. | — | 75.09 | — |

1.-15. (canceled)

16. A thermoplastic composition comprising
A) 30.0 to 100.0 parts by wt. of at least one aromatic polycarbonate,
B) 0.0 part by wt. to 50.0 parts by wt. of rubber-modified graft polymer and/or vinyl copolymer,
C) 0.00 to 50.00 part by wt. of polyester,
D) 5.0 to 50.0 parts by wt. of at least one inorganic filler having a grain shape selected from the group consisting of spherical, cubic, tabular, discus-shaped and lamellar geometries,
E) 0.00 to 5.00 parts by wt. of further additives,
wherein the sum of the parts by weight of components A) to E) adds up to 100 parts by weight.

17. The composition according to claim 16, wherein the composition comprises the components in the following amounts:
A) 50.0 to 85.0 parts by wt. of at least one aromatic polycarbonate,
B) 0 part by wt. to 20.0 parts by wt. of rubber-modified graft polymer and/or vinyl copolymer,
C) 10.00 to 25.00 part by wt. of polyester,
D) 15.0 to 30.0 parts by wt. of at least one inorganic filler having a grain shape selected from the group consisting of spherical, cubic, tabular, discus-shaped and lamellar geometries,
E) 0.75 to 1.25 parts by wt. of further conventional additives,

18. The composition according to claim 16, wherein component D has a grain shape selected from the group consisting of spherical, cubic, and lamellar geometries.

19. The composition according to claim 16, wherein component D is selected from the group consisting of thermally inert inorganic materials, which includes nitrides, oxides, mixed oxides, carbides, powdered quartz, amorphous SiO₂, ground sand, glass particles, silicates or alumosilicates and graphite.

20. The composition according to claim 19, wherein component D is selected from the group consisting of boron nitride, cerium oxide, aluminium oxide, tungsten carbide, silicon carbide, boron carbide, quartz flour, amorphous SiO₂, ground sand, glass powder, glass spheres, silicates or alumosilicates and highly pure synthetic graphite.

21. The composition according to claim 16, wherein component D is quartz.

22. The composition according to claim 16, wherein the at least one inorganic filler has an average diameter d_{50%} of from 0.1 to 10 μm.

23. The composition according to claim 16, wherein the silicates have an average diameter d_{50%} of from 2.0 to 10 μm.

24. The composition according to claim 16, wherein the at least one inorganic filler is sized.

25. A method for the production of a shaped part comprising utilizing the composition according to claim 16, wherein the shaped part has a low isotropic coefficient of thermal expansion, improved dimensional accuracy, high surface quality, also during and after exposure to heat, high reflectance and good metallizability.

26. A process for the production of a shaped part having an increased scratch resistance of the surface, improved dimensional accuracy and improved gloss of the surface, comprising the steps:
a) compounding of the compositions comprising components A) to E) for the preparation of granules of the compositions according to claim 16,
b) injection moulding of the shaped part from the granules prepared in this way with dynamic mould temperature control.

27. The process according to claim 26, further comprising metalizing of the surface as a further step.

28. The process according to claim 26, wherein the surface of the shaped part is subjected to plasma pretreatment with an alternating frequency of 40 kHz and a voltage of >1,000 V at the plasma source.

29. The process according to claim 27, wherein the metal is aluminium.

30. The process according to claim 27, wherein a further corrosion protection layer is applied by means of plasma polymerization.
